(19) United States
(12) Patent Application Publication
(10) Pub. No.: US 2015/0225001 A1
(43) Pub. Date: Aug. 13, 2015

(54) CENTER PLATE FOR A RAILWAY CAR AND METHOD OF ASSEMBLING THE SAME

(71) Applicant: American Railcar Industries, Inc., St. Charles, MO (US)

(72) Inventor: Bradley Shane Hale, Paragould, AR (US)

(73) Assignee: American Railcar Industries, Inc., St. Charles, MO (US)

(21) Appl. No.: 14/177,554

(22) Filed: Feb. 11, 2014

(51) Int. Cl. B61F 5/04; B23K 37/04; B23K 9/18; B23K 20/00; B23K 9/16

(52) U.S. Cl. CPC B61F 5/04; B23K 20/002; B23K 9/164; B23K 9/18; B23K 37/04

(57) ABSTRACT

A center plate assembly for use in a railcar includes a substantially square standoff portion configured to be inserted into a center plate pocket defined in a portion of a sill assembly. The center plate assembly also includes a lower cap portion configured to be coupled to a truck assembly. The center plate assembly further includes a weld portion positioned between and extending from the standoff portion and the lower cap portion. The weld portion defines a weld region for coupling the center plate assembly to the sill assembly. The weld region is arcuate.

### BACKGROUND OF THE INVENTION

The present disclosure relates generally to railway cars and related components, and more particularly to a center plate for a railway car and a method of assembling railway cars with such center plate.

Railroad cars have been used for many years to transport a wide variety of commodities. For example, railway tank cars transport fluids including liquids, e.g., demineralized water, and gasses, e.g., hydrogen. Also, for example, railway hopper cars transport flowable solids including coal, grains, and rock. Further, for example, railway box cars transport bulky items that require some protection from the elements including appliances, vehicle components and machine components.

At least some of these known railroad cars include a center sill (i.e., a central longitudinal member), which is the primary structural member of the underframe of the railcar which forms the “backbone” of the underframe, and extends along much of the length of the railcar. The center sills may be either through-sills, that extend the full length of the railway car between two opposing striker assemblies, or stub sills that extend between a portion of the railway car to a striker assembly.

Many center sills and stub sills include an end assembly in the immediate vicinity of a truck assembly. Such known end assemblies include an end bottom cover plate that defines a rectangular or square pocket that is configured to receive a known center plate assembly. Such known center plate assemblies include a square base, or standoff that transitions to a round, approximately 16-inch diameter center plate. The square standoff is positioned within the square pocket of the end bottom cover plate to define four weld fill regions, i.e., one weld fill region at each corner of the standoff. The center plate assembly is coupled to the end bottom cover plate of the sill through approximately eight weld passes for each weld fill region with a fillet reinforcement, thereby resulting in 32 weld passes. The numerous welding activities impact the costs of manufacturing such railcars. For example, the numerous welding activities are labor-intensive and prevent high-speed production through automation of such railcars. The costs of manufacturing railcars are increased in proportion to the labor applied. In addition, the potential for introducing weld defects is increased.

Accordingly, a center plate assembly and a method of assembling and coupling to a sill are needed that facilitates cost-effective production. Specifically, a center plate assembly and a method of coupling to a sill are needed such that the center plate assemblies have at least standard stress strength characteristics while reducing the amount of welding required.

### BRIEF DESCRIPTION OF THE INVENTION

In one aspect, a center plate assembly for use in a railcar is provided. The center plate assembly includes a substantially square standoff portion configured to be inserted into a center plate pocket defined in a portion of a sill assembly. The center plate assembly also includes a lower cap portion configured to be coupled to a truck assembly. The center plate assembly further includes a weld portion positioned between and extending from the standoff portion and the lower cap portion. The weld portion defines a weld region for coupling the center plate assembly to the sill assembly. The weld region is arcuate.

In another aspect, a railway car is provided. The railway car includes at least one sill assembly and at least one truck assembly coupled to the at least one sill assembly. The railway car also includes at least one center plate pocket defined in a portion of the at least one sill assembly. The at least one center plate pocket is configured to receive a center plate assembly that includes a substantially square standoff portion configured to be inserted into the center plate pocket. The center plate assembly also includes a lower cap portion coupled to the truck assembly. The center plate assembly further includes a weld portion positioned between and extending from the standoff portion and the lower cap portion. The weld portion defines a weld region for coupling to the at least one sill assembly. The weld region is arcuate.

In another aspect, a method of assembling a railcar is provided. The method includes providing a sill assembly including a center plate pocket defined therein. The method also includes forming a center plate assembly that includes a substantially square standoff portion, a lower cap portion, and a weld portion positioned between and extending from the standoff portion and the lower cap portion. The weld portion is arcuate. The method further includes inserting the center plate assembly into the center plate pocket. The method also includes welding the weld portion to the sill assembly comprising forming an arcuate weld substantially continuously.

### BRIEF DESCRIPTION OF THE DRAWINGS

FIGS. 1-6 show exemplary embodiments of the apparatus described herein.

FIG. 1 is a schematic side view of an exemplary high-pressure tanker railcar;

FIG. 2 is a schematic overhead perspective view of an exemplary stub sill that may be used with the high-pressure tanker railcar shown in FIG. 1;

FIG. 3 is a schematic side view of an exemplary center plate assembly that may be used with the stub sill shown in FIG. 2;

FIG. 4 is a schematic bottom perspective view of the center plate assembly shown in FIG. 3;

FIG. 5 is a schematic side view of a portion of an exemplary submerged arc welding system that may be used to couple the center plate assembly shown in FIGS. 3 and 4 to the stub sill shown in FIG. 2; and

FIG. 6 is a schematic side view of a continuous compound bevel groove weld that may be used to couple an alternative center plate assembly to an alternative stub sill shown in FIG. 2.

### DETAILED DESCRIPTION OF THE INVENTION

The exemplary methods and apparatus described herein overcome at least some disadvantages of known railway cars by providing a center plate assembly that eliminates the need to have extensive welding activities to fabricate the railcar. Specifically, the embodiments described herein provide a center plate assembly that includes a coupling portion that is substantially circular and facilitates a single weld pass to couple the center plate assembly to a bottom cover plate. Such configuration facilitates using welding automation to couple the center plate assembly to the bottom cover plate, thereby decreasing the time and costs of railcar assembly. By using continuous automated welding, weld consistency is increased and weld defects and associated rework are reduced. In addition, the automated welding process will facilitate faster weld device travel speeds and deeper penetration, thereby facilitating higher quality welds than the current process. Specifically, a continuous weld reduces the number of arc starts and stops, which is where weld defects are typically found. Moreover, such configuration facilitates increasing the contact area between the center plate assembly and the bottom cover plate of the stub sill.

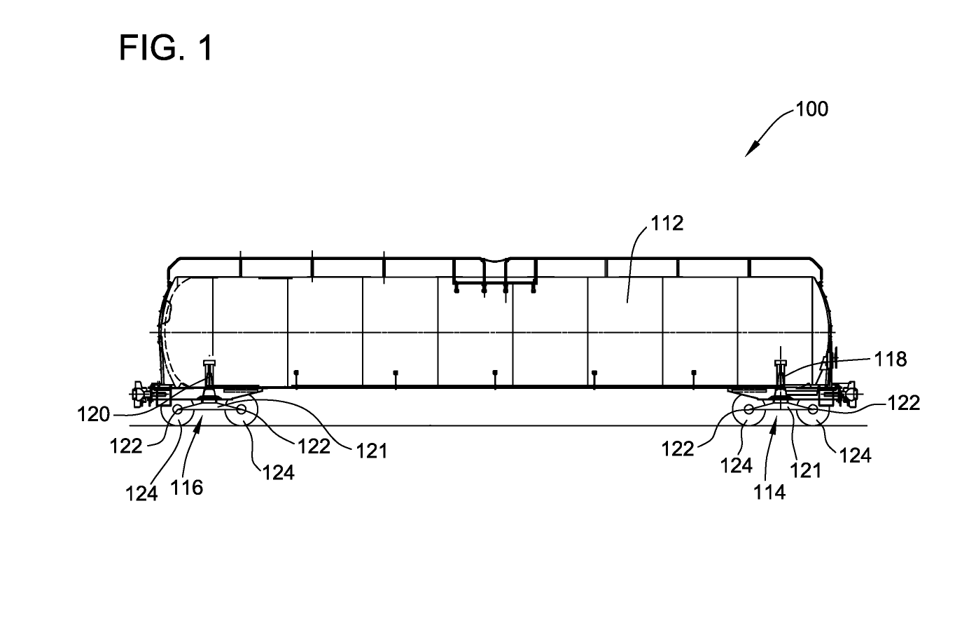

FIG. 1 is a side view of an exemplary tanker railcar 100. Tanker railcar 100 is configured to store and/or transport materials, such as chlorine, anhydrous ammonia, vegetable oil, sulfuric acid, hydrochloric acid, a commodity, and/or any other suitable material in gas, solid, and/or liquid state.

Tanker railcar 100 includes a tank 112, a front stub sill assembly 114, and a rear stub sill assembly 116. Sill assemblies 114 and 116 are coupled to tank 112. Bolster assemblies 118 and 120 are configured to stabilize tank 112 on sill assemblies 114 and 116. More specifically, front bolster assembly 118 is coupled to tank 112 and front sill assembly 114, and rear bolster assembly 120 is coupled to tank 112 and rear sill assembly 116. Each sill assembly 114 and 116 includes a truck assembly 121 having a pair of axles 122 each coupled to a pair of wheels 124.

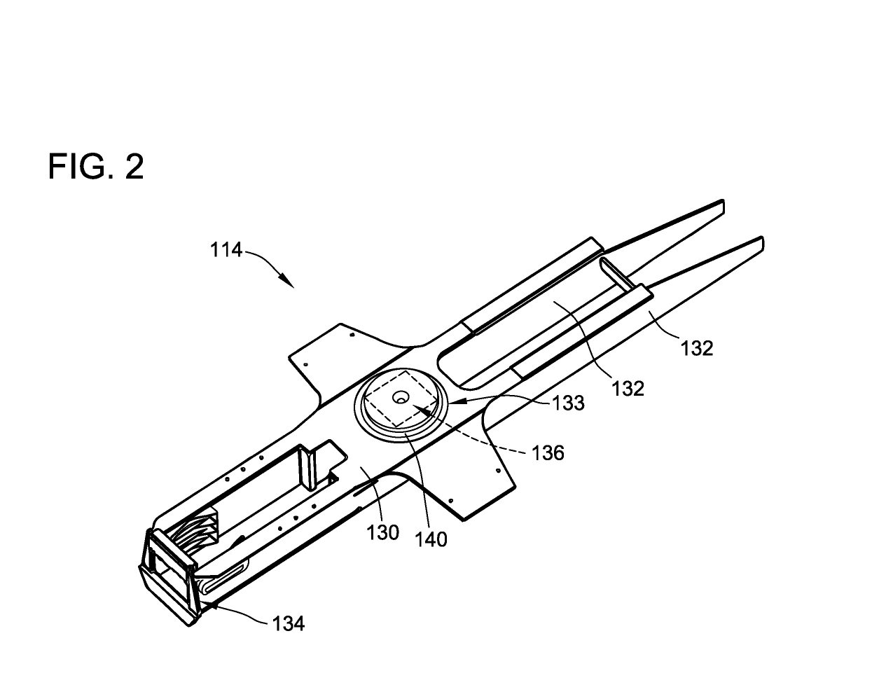

FIG. 2 is a schematic overhead perspective view of stub sill assembly 114 that may be used with tanker railcar 100 (shown in FIG. 1). Stub sill assembly 116 (shown in FIG. 1) is substantially similar. In the exemplary embodiment, stub sill assembly 114 includes a bottom cover plate 130 coupled to a plurality of side web legs 132. Bottom cover plate 130 defines a coupling surface 133. Stub sill assembly 114 also includes a striker assembly 134. A center plate pocket 136 (shown in phantom) is defined in bottom cover plate 130 and is configured to receive a center plate assembly 140. Truck assembly 121 (shown in FIG. 1) is configured to be coupled to center plate assembly 140.

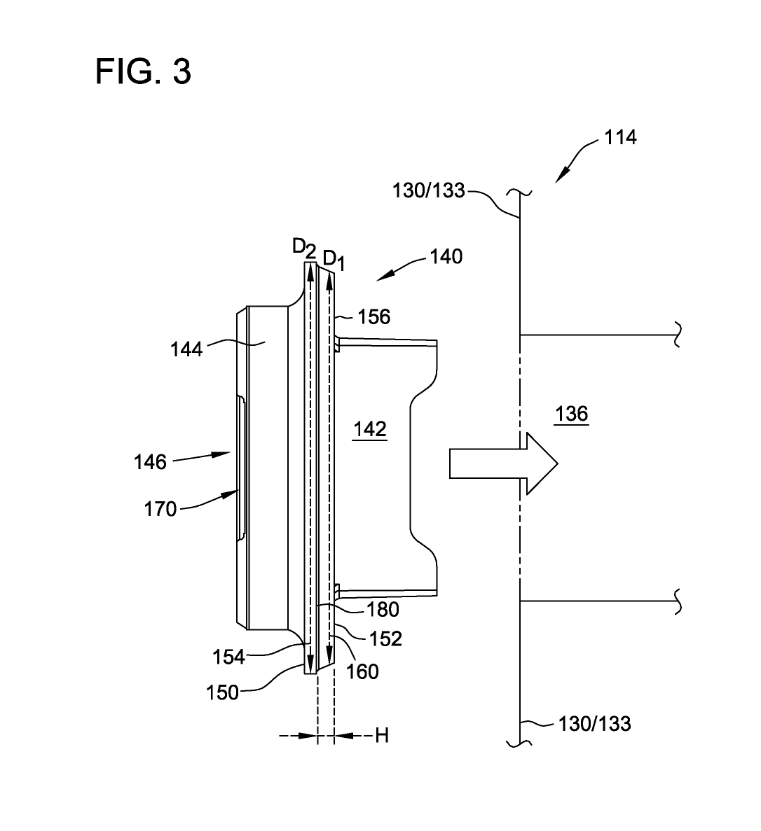

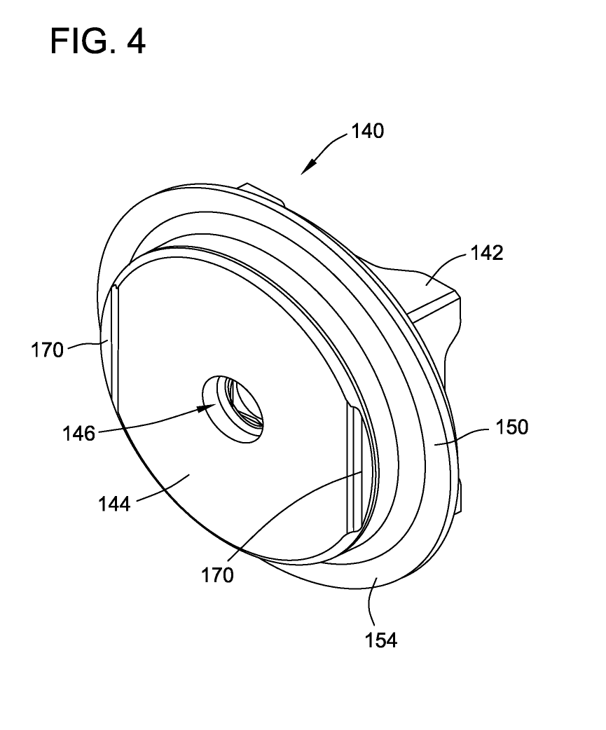

FIG. 3 is a schematic side view of center plate assembly 140 that may be used with stub sill assembly 114. FIG. 4 is a schematic bottom perspective view of center plate assembly 140. In the exemplary embodiment, center plate assembly 140 includes a substantially square standoff portion 142 configured to be inserted into center plate pocket 136. Center plate assembly 140 also includes a lower cap portion 144 that defines a cavity 146 configured to receive a portion of truck assembly 121 (shown in FIG. 1) for coupling truck assembly 121 to center plate assembly 140.

Center plate assembly 140 further includes a weld portion 150 positioned between, and extending from, standoff portion 142 and lower cap portion 144. In the exemplary embodiment, weld portion 150 includes a first portion 152 coupled to standoff portion 142 and a second portion 154 coupled to first portion 152. First portion 152 has a first diameter D₁ and second portion 154 has a second diameter D₂ that is greater than first diameter D₁. First portion 152 defines a surface face 156. First portion 152 and second portion 154 further define an arcuate weld region 160 at the arcuate intersection of portions 152 and 154. In the exemplary embodiment, first portion 152 and second portion 154 further define a substantially circular weld region 160 at the substantially circular intersection of portions 152 and 154. Alternatively, first portion 152 and second portion 154 further define weld region 160 at the intersection of portions 152 and 154 that are shaped in any configuration that enables center plate assembly 140 as described herein, including arcuate shapes such as, without limitation, elliptical. Also, lower cap portion 144 defines a pair of bevel flat portions 170.

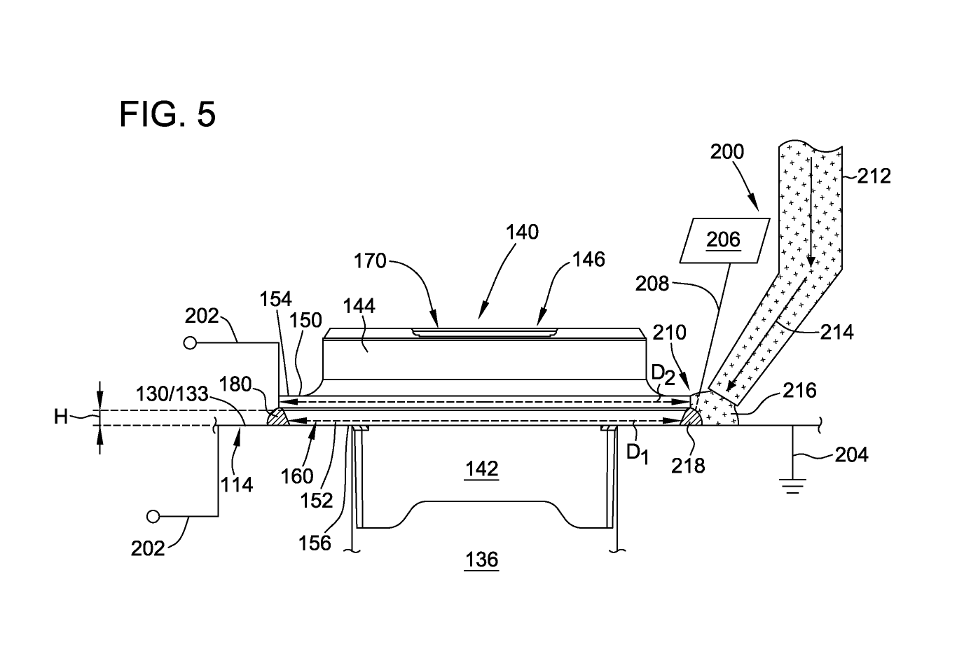

FIG. 5 is a schematic side view of a portion of an exemplary submerged arc welding (SAW) system 200 that may be used to couple center plate assembly 140 to stub sill assembly 114. In the exemplary embodiment, SAW system 200 is substantially automated. Alternatively, SAW system 200 may be either semi-automated or substantially manual. SAW system 200 includes direct current (DC) electrical leads 202 and ground 204 coupled to center plate assembly 140 and stub sill assembly 114 in any configuration that enables operation of SAW system 200 as described herein. SAW system 200 also includes apparatus 206 that delivers electrode wire 208 to a weld site 210. Apparatus 206 includes any devices that enable operation of SAW system 200 as described herein, including, without limitation, drive rolls, drive motors, spools, and guides. SAW system 200 further includes a flux delivery hopper 212 that delivers flux material 214 to weld site 210 to form a flux mound 216 that submerges electrode wire 208 and facilitates formation of a weld pool 218. In some embodiments, SAW system 200 is stationary and center plate assembly 140 and stub sill assembly 114 are rotated. In some other embodiments, SAW system 200 is rotatable about center plate assembly 140 and stub sill assembly 114.

A method of assembling tanker railcar 100 (shown in FIG. 1) includes inserting center plate assembly 140, i.e., standoff portion 142 into center plate pocket 136 such that surface face 156 is positioned a predetermined height H above coupling surface 133. In the exemplary embodiment, H is approximately 0.3175 centimeters (cm) (0.125 inches (in.)). Alternatively, H is any value that enables operation of center plate assembly 140 as described herein. Also, surface face 156 is substantially flat. Automated SAW system 200 is used to deposit weld material 180 to weld region 160 such that weld material 180 extends height H between surface face 156 and coupling surface 133.

In some embodiments, center plate assembly 140 and stub sill assembly 114 are translated, e.g., rotated with respect to substantially stationary SAW system 200 as weld material 180 is deposited in weld region 160. Alternatively, in some other embodiments, SAW system 200 is translated, e.g., rotated about substantially stationary center plate assembly 140 and stub sill assembly 114 as weld material 180 is deposited in weld region 160. Weld material 180 may be deposited through one of a fully-automated, semi-automated, or manual welding process.

In the exemplary embodiment, the welding activity is substantially continuous and weld material 180 is substantially circular. Weld material is deposited in weld region 160 substantially continuously to form a singular, continuous weld with one start action and one stop action. Also, as described above for first portion 152, second portion 154, and weld region 160, they have any shape that enables center plate assembly 140 to operate as described herein, including arcuate shapes such as, without limitation, elliptical. As such, weld material 180 may also form similar alternative arcuate shapes that facilitate substantially continuous welding activity to deposit weld material 180.

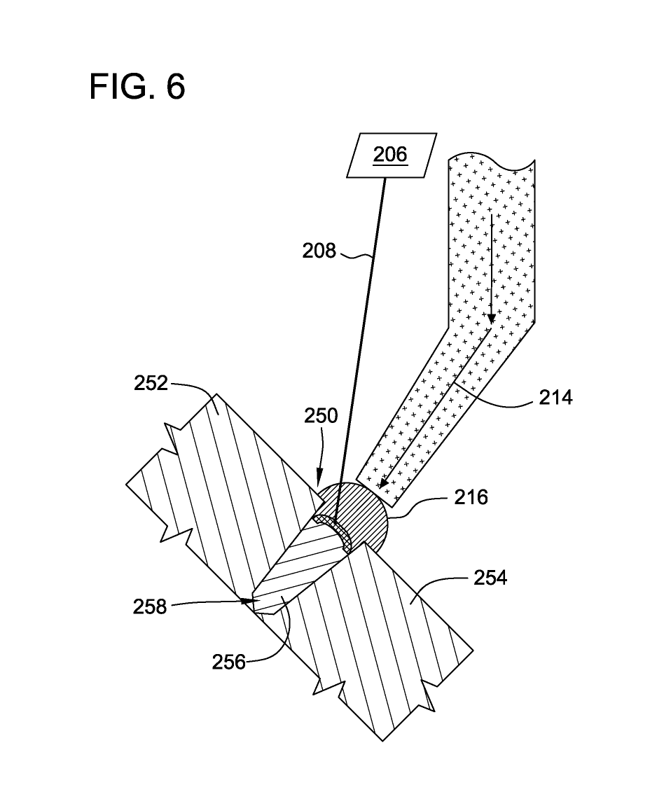

FIG. 6 is a schematic side view of a continuous compound bevel groove weld 250 that may be used to couple an alternative center plate assembly 252 to an alternative stub sill assembly 254. Alternative center plate assembly 252 and alternative stub sill assembly 254 have any configurations and orientations that enable forming continuous compound bevel groove weld 250 as described herein. SAW system 200 is oriented as shown to deposit weld material 256 in weld V-groove 258 defined between center plate assembly 252 and stub sill assembly 254. Operation of SAW system 200 is similar to that described above.

Alternatively, rather than using SAW processes, any welding process that enables coupling of center plate assembly 140 to stub sill assemblies 114 and 116 as described herein may be used, including, without limitation, flux-cored arc welding (FCAW), gas metal arc welding (GMAW), shielded metal arc welding (SMAW), and gas tungsten arc welding (GTAW). As with SAW, welding with FCAW, GMAW, SMAW, and GTAW may be either substantially automated, semi-automatic, or substantially manual.

As described herein, center plate assembly 140 is used with stub sill assemblies 114 and 116 to assemble tanker railcar 100 (all shown in FIG. 1). Alternatively, center plate assembly 140 may be used with a through-sill assembly to assemble railway hopper cars. Also, alternatively, plate assembly 140 may be used with any sill assembly in any railway car that enables operation of center plate assembly 140 as described herein, e.g., without limitation, railway gondola cars and railway box cars.

The exemplary methods and apparatus described herein overcome at least some disadvantages of known railway cars by providing a center plate assembly that eliminates the need to have extensive welding activities to fabricate the railcar. Specifically, the embodiments described herein provide a center plate assembly that includes a coupling portion that is substantially circular and facilitates a single weld pass to couple the center plate assembly to a bottom cover plate. Such configuration facilitates using welding automation to couple the center plate assembly to the bottom cover plate, thereby decreasing the time and costs of railcar assembly. By using continuous automated welding, weld consistency is increased and weld defects and associated rework are reduced. In addition, the automated welding process will facilitate faster weld device travel speeds and deeper penetration, thereby facilitating higher quality welds than the current process. Specifically, a continuous weld reduces the number of arc starts and stops, which is where weld defects are typically found. Moreover, such configuration facilitates increasing the contact area between the center plate assembly and the bottom cover plate of the stub sill.

Exemplary embodiments of a center plate assembly for a railway tanker car and method of assembling/fabricating the same are described above in detail. The center plate assembly and method are not limited to the specific embodiments described herein, but rather, components of apparatus and/or steps of the method may be utilized independently and separately from other components and/or steps described herein. For example, the center plate assembly may also be used in combination with other railway cars and associated assembly/fabrication methods, and are not limited to practice with only the railway tanker car and assembly/fabrication methods as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A center plate assembly for use in a railcar comprising:
a substantially square standoff portion configured to be inserted into a center plate pocket defined in a portion of a sill assembly;
a lower cap portion configured to be coupled to a truck assembly; and
a weld portion positioned between and extending from said standoff portion and said lower cap portion, wherein said weld portion defines a weld region for coupling said center plate assembly to the sill assembly, said weld region is at arcuate.

2. The center plate assembly in accordance with claim 1, wherein said lower cap portion defines a plurality of bevel flat portions.

3. The center plate assembly in accordance with claim 1, wherein said weld portion comprises a first portion coupled to said standoff portion and a second portion coupled to said first portion, wherein said first portion has a first diameter and said second portion has a second diameter greater than the first diameter, said first portion and said second portion further define a substantially circular and substantially continuous weld region.

4. A railway car comprising:
at least one sill assembly;
at least one truck assembly coupled to said at least one sill assembly; and
at least one center plate pocket defined in a portion of said at least one sill assembly, wherein said at least one center plate pocket is configured to receive a center plate assembly comprising:
a substantially square standoff portion configured to be inserted into said center plate pocket;
a lower cap portion coupled to said truck assembly; and
a weld portion positioned between and extending from said standoff portion and said lower cap portion, wherein said weld portion defines a weld region for coupling to said at least one sill assembly, said weld region is arcuate.

5. The railway car in accordance with claim 4, wherein said at least one sill assembly comprises a bottom cover plate, said center plate assembly is welded to said bottom cover plate.

6. The railway car in accordance with claim 4, wherein said at least one sill assembly is a stub sill.

7. The railway car in accordance with claim 4, wherein said at least one sill assembly is a through-sill.

8. The railway car in accordance with claim 4, wherein said lower cap portion defines a plurality of bevel flat portions.

9. The railway car in accordance with claim 4, wherein said weld portion comprises a first portion coupled to said standoff portion and a second portion coupled to said first portion, wherein said first portion has a first diameter and said second portion has a second diameter greater than the first diameter, said first portion and said second portion further define a substantially circular and substantially continuous weld region.

10. The railway car in accordance with claim 4, wherein said at least one sill assembly, said at least one truck assembly, and said center plate assembly at least partially define an undercarriage.

11. A method of assembling a railcar, said method comprising:
providing a sill assembly including a center plate pocket defined therein;
forming a center plate assembly that includes a substantially square standoff portion, a lower cap portion, and a weld portion positioned between and extending from the standoff portion and the lower cap portion, wherein the weld portion is arcuate;
inserting the center plate assembly into the center plate pocket; and
welding the weld portion to the sill assembly comprising forming an arcuate weld substantially continuously.

12. The method in accordance with claim 11, wherein the sill assembly includes a bottom cover plate, wherein inserting the center plate assembly into the center plate pocket comprises:
positioning the sill assembly such that the bottom cover plate faces upward; and
inserting the substantially square standoff portion into the center plate pocket and resting at least a portion of the weld portion on at least a portion of the bottom cover plate.

13. The method in accordance with claim 11, further comprising coupling a truck assembly to the center plate assembly.

14. The method in accordance with claim 11, wherein providing a sill assembly comprises providing a stub sill.

15. The method in accordance with claim 11, wherein providing a sill assembly comprises providing a through-sill.

16. The method in accordance with claim 11, further comprising defining a plurality of bevel flat portions in the lower cap portion.

17. The method in accordance with claim 11, wherein forming a center plate assembly that includes a weld portion comprises:
forming a first portion coupled to the standoff portion, wherein the first portion has a first diameter; and
forming a second portion coupled to the first portion, wherein the second portion has a second diameter greater than the first diameter.

18. The method in accordance with claim 17, wherein forming the first portion and the second portion comprises defining a substantially circular weld region.

19. The method in accordance with claim 11, wherein inserting the center plate assembly into the center plate pocket of the sill assembly and welding the weld portion to the sill assembly comprises at least partially assembling an undercarriage.

20. The method in accordance with claim 11, wherein welding the weld portion to the sill assembly comprises forming the arcuate weld substantially continuously using a welding process including at least one of submerged arc welding (SAW), flux-cored arc welding (FCAW), gas metal arc welding (GMAW), shielded metal arc welding (SMAW), and gas tungsten arc welding (GTAW).

21. The method in accordance with claim 20, wherein forming an arcuate weld substantially continuously comprises using only one start of the welding process and only one stop of the welding process.

22. The method in accordance with claim 20, wherein forming an arcuate weld substantially continuously comprises forming a continuous weld, wherein the welding process is one of fully-automated, semi-automated, and manual.

23. The method in accordance with claim 20 further comprising providing a welding system and positioning the welding system proximate the centerplate assembly and the sill assembly, wherein forming an arcuate weld substantially continuously comprises one of:
translating the centerplate assembly and the sill assembly with respect to a substantially stationary welding system; and
translating the welding system with respect to a substantially stationary centerplate assembly and the sill assembly.

24. The method in accordance with claim 20, wherein forming an arcuate weld substantially continuously comprises forming a continuous compound bevel groove weld.
